(19) United States
(12) Patent Application Publication
(10) Pub. No.: US 2025/0182656 A1
(43) Pub. Date: Jun. 5, 2025

(54) Circuit Device And Display System

(71) Applicant: SEIKO EPSON CORPORATION, Tokyo (JP)

(72) Inventor: Yasutoshi AKIBA, Chino (JP)

(21) Appl. No.: 18/961,817

(22) Filed: Nov. 27, 2024

(30) Foreign Application Priority Data
Nov. 30, 2023 (JP) 2023-203292

(51) Int. Cl. G09G 3/00

(52) U.S. Cl. CPC G09G 3/001; G09G 2320/0242; G09G 2320/0626; G09G 2354/00; G09G 2360/144; G09G 2380/10

(57) ABSTRACT

A circuit device configured to control a display device includes a region determination circuit configured to determine a region to which a pixel belongs, and a color correction circuit configured to perform color correction on input image data based on the region determination result. Light from the first light source controlled based on a first global dimming value enters a first region in the display panel, and light from the second light source controlled based on a second global dimming value enters a second region in the display panel. The color correction circuit performs color correction on first image data of the input image data to be displayed in the first region based on the first global dimming value, and performs color correction on second image data of the input image data to be displayed in the second region based on the second global dimming value.

The present application is based on, and claims priority from JP Application Serial Number 2023-203292, filed Nov. 30, 2023, the disclosure of which is hereby incorporated by reference herein in its entirety.

### BACKGROUND

### 1. Technical Field

The present invention relates to a circuit device, a display system, and the like.

### 2. Related Art

JP-A-2017-194548 discloses an image display apparatus used for head-up displays (HUDs). This image display apparatus reflects first image light projected from a light source via a microlens array toward a windshield of a vehicle by using a magnifying mirror, and thereby a virtual image corresponding to the first image is superimposed and displayed on the scenery ahead of the vehicle. This virtual image is, for example, an arrow that is pointing the traveling direction of the vehicle. This image display apparatus also reflects second image light projected from the light source by using a mirror toward the windshield and then a self-luminous interlayer in the windshield emits light, and thereby a real image corresponding to the second image is displayed to the driver. This real image is, for example, a display indicating the speed of the vehicle.

The image display apparatus in JP-A-2017-194548 projects the light from the common light source by using the mirrors having different magnifications, and thus the luminance differs on the projection surface.

### SUMMARY

According to an aspect of the present disclosure, a circuit device configured to control a display device including a first light source, a second light source, and a display panel is provided. The circuit device includes a region determination circuit configured to determine a region to which a pixel belongs, and a color correction circuit configured to perform color correction on input image data based on the region determination result. Light from the first light source controlled based on a first global dimming value enters a first region in the display panel, and light from the second light source controlled based on a second global dimming value enters a second region in the display panel, the color correction circuit performs color correction on first image data of the input image data to be displayed in the first region based on the first global dimming value, and performs color correction on second image data of the input image data to be displayed in the second region based on the second global dimming value.

According to another aspect of the present disclosure, a display system including the circuit device described above and the display device is provided.

### BRIEF DESCRIPTION OF THE DRAWINGS

FIG. 1 illustrates an example configuration of a circuit device and a display system according to the embodiment.

FIG. 2 illustrates a specific example of a display device.

FIG. 3 illustrates an example of a first image in a first region and a second image in a second region.

FIG. 4 illustrates a comparative example.

FIG. 5 illustrates an example first configuration of a circuit device according to the embodiment.

FIG. 6 illustrates an example second configuration of a circuit device according to the embodiment.

FIG. 7 illustrates an example third configuration of a circuit device according to the embodiment.

FIG. 8 illustrates a detailed example configuration of a circuit device according to the embodiment.

FIG. 9 illustrates an example configuration of a head-up display that is an example display system.

### DESCRIPTION OF EMBODIMENTS

Hereinafter, an embodiment of the disclosure will be described in detail. The embodiment described below does not unduly limit the scope of the claims, and not all configurations described in this embodiment are essential.

### 1. Circuit Device and Display System

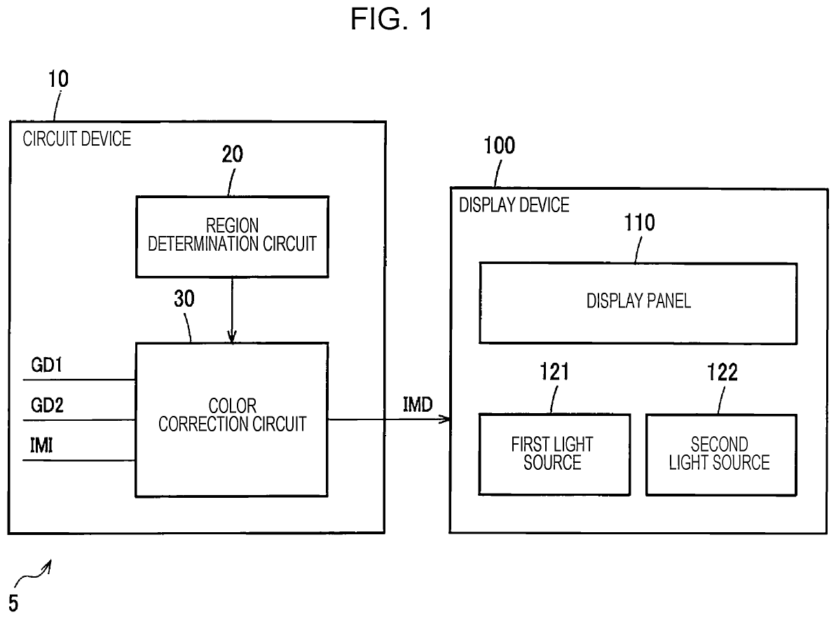

FIG. 1 illustrates an example configuration of a circuit device 10 and a display system 5 including the circuit device 10 according to the embodiment. The circuit device 10 includes a region determination circuit 20 and a color correction circuit 30. The display system 5 includes the circuit device 10 and a display device 100. It should be noted that the configurations of the circuit device 10 and the display system 5 according to the embodiment are not limited to the configurations illustrated in FIG. 1, and various modifications may be made, for example, some components may be omitted, other components may be added, or some components may be replaced with other components. For example, the circuit device 10 may include, in addition to the region determination circuit 20 and the color correction circuit 30, other circuits, such as a light source control circuit, a global dimming value generation circuit, or an interface circuit. The display system 5 may also include other devices and circuits, such as a processing device.

The display device 100 displays an image based on image data. The image data may also be referred to as video data, and the display device 100 displays video based on video data. The display device 100 is, for example, a head-up display for displaying a virtual image into the user's field of vision, a cluster display that is a display of a meter panel, a center information display, or an in-vehicle display device such as an electron mirror. Alternatively, the display device 100 may be a head-mounted display device (HMD), a television device, or a display for information processing devices.

The display device 100 includes a display panel 110, a first light source 121, and a second light source 122. The display panel 110 is, for example, an electrooptic panel such as a liquid crystal display panel or a digital micromirror panel. For example, the display panel 110 is an electrooptic panel having electrooptic elements for modulating incident light from a light source. The first light source 121 and the second light source 122 are implemented by, for example, a light source element such as a light-emitting diode (LED). The first light source 121 and the second light source 122 are used, for example, as backlights for the display panel 110. The display device 100 may include a light source driver that drives the first light source 121 and the second light source 122 and a display driver that drives the display panel 110.

The circuit device 10 is, for example, an integrated circuit device that has a plurality of circuit elements integrated on a semiconductor substrate. The display device 100 displays an image based on image data IMD output by the circuit device 10. When the display device 100 is a head-up display (HUD), the circuit device 10 serves as an HUD controller.

The circuit device 10 includes the region determination circuit 20 and the color correction circuit 30. The region determination circuit 20 determines a region to which a pixel belongs. For example, the region determination circuit 20 determines a region to which each of a plurality of pixels in input image data IMI belongs. For example, the region determination circuit 20 determines whether each of pixels in input image data IMI belongs to the first region or the second region. The region can be determined based on, for example, coordinates (X, Y) of a pixel in the input image data IMI. For example, the region determination circuit 20 performs the region determination by determining whether coordinates of a pixel belong to the first region or the second region.

The color correction circuit 30 performs color correction on input image data IMI based on a result of the region determination in the region determination circuit 20. For example, the color correction circuit 30 performs color correction based on a first global dimming value GD1 and a second global dimming value GD2. For example, the color correction circuit 30 performs color correction on input image data IMI by using a first global dimming value GD1 and a second global dimming value GD2 based on a result of a determination whether each pixel in the input image data IMI belongs to the first region or the second region. The image data IMD subjected to color correction is output from the circuit device 10 to the display device 100. The color correction may be referred to as luminance correction or luminance adjustment, and the color correction circuit 30 may be referred to as a luminance correction circuit or a luminance adjustment circuit.

For example, in this embodiment, light from the first light source 121 controlled based on a first global dimming value GD1 enters the first region of the display panel 110, and light from the second light source 122 controlled based on a second global dimming value GD2 enters the second region of the display panel 110. The first region and the second region are different regions in the display panel 110 and may be of various shapes, for example, rectangular or circular. For example, the first region is a region in which a first display group that is displayed in the display panel 110 is displayed, and the second region is a region in which a second display group that is displayed in the display panel 110 is displayed. For example, by using a light source control circuit or a light source driver, which are not illustrated, dimming control of the first light source 121 based on a first global dimming value GD1 and dimming control of the second light source 122 based on a second global dimming value GD2 are performed. This dimming control is, for example, dimming control referred to as global dimming performed based on results of detection of ambient light or the like. For example, the control under the global dimming is performed such that when ambient light is bright, the amounts of the light from the first light source 121 and the second light source 122 are increased and when ambient light is dark, the amounts of the light from the first light source 121 and the second light source 122 are reduced. It should be noted that the number of light sources in the display device 100 is not limited to two and may be three or more. For example, when a third light source is provided to the display device 100, light from the third light source controlled based on a third global dimming value enters a third region of the display panel 110.

The color correction circuit 30 performs color correction on first image data of input image data IMI to be displayed in the first region based on a first global dimming value GD1. The color correction circuit 30 performs color correction also on second image data of input image data IMI to be displayed in the second region based on a second global dimming value GD2. For example, the color correction circuit 30 independently performs first luminance adjustment for adjusting the luminance of a first image in the first region based on a first global dimming value GD1 and second luminance adjustment for adjusting the luminance of a second image in the second region based on a second global dimming value GD2. For example, a first global dimming value GD1 and a second global dimming value GD2 change depending on results of detection of ambient light and the like, and each dimming value can be independently set. Accordingly, by performing the color correction on the first image data based on a first global dimming value GD1 and the color correction on the second image data based on a second global dimming value GD2 by using the color correction circuit 30, the luminance of the first light source 121 and the second light source 122 is changed depending on changes in ambient light or the like and different luminance adjustments can be performed on the first image data in the first region and the second image data in the second region. For example, an adjustment can be performed such that the luminance levels in the first region and the second region become a substantially same luminance level on a projection surface after reflection by mirror.

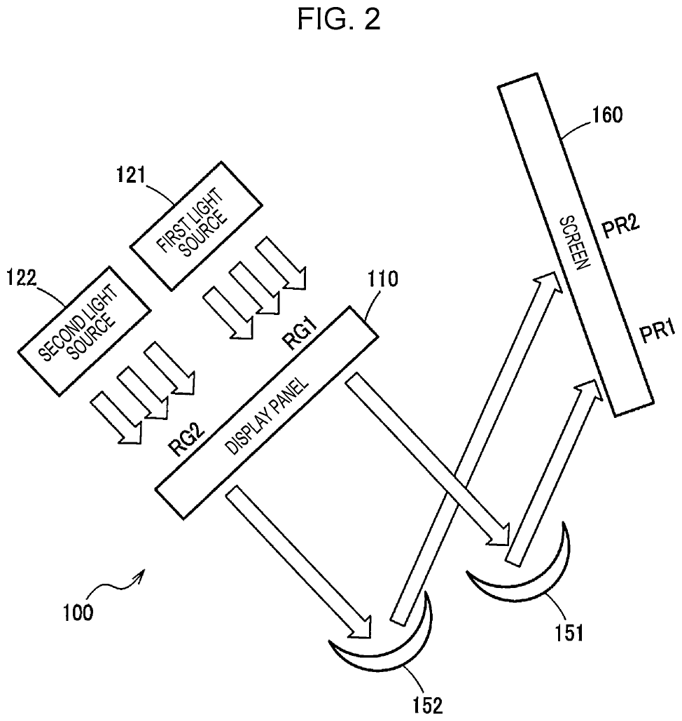

For example, FIG. 2 illustrates a specific example of the display device 100. In FIG. 2, the light from the first light source 121 whose luminance is controlled based on a first global dimming value GD1 enters the first region RG1 in the display panel 110, and then, the light of a first image (first video) in the first region RG1 is reflected by a first optical system 151 and projected in a first projection region PR1 in a screen 160. The light from the second light source 122 whose luminance is controlled based on a second global dimming value GD2 enters the second region RG2 in the display panel 110, and then, the light of a second image (second video) in the second region RG2 is reflected by a second optical system 152 and projected in a second projection region PR2 in the screen 160. In FIG. 2, the first optical system 151 is a first mirror, and more specifically, for example, a first concave mirror. The second optical system 152 is a second mirror, and more specifically, for example, a second concave mirror. The use of the concave mirrors enables correction of distortion of a virtual image. The concave mirrors are magnifying mirrors and magnification rates can be set. The screen 160 is, for example, a transparent screen, and more specifically, for example, a windshield of a vehicle.

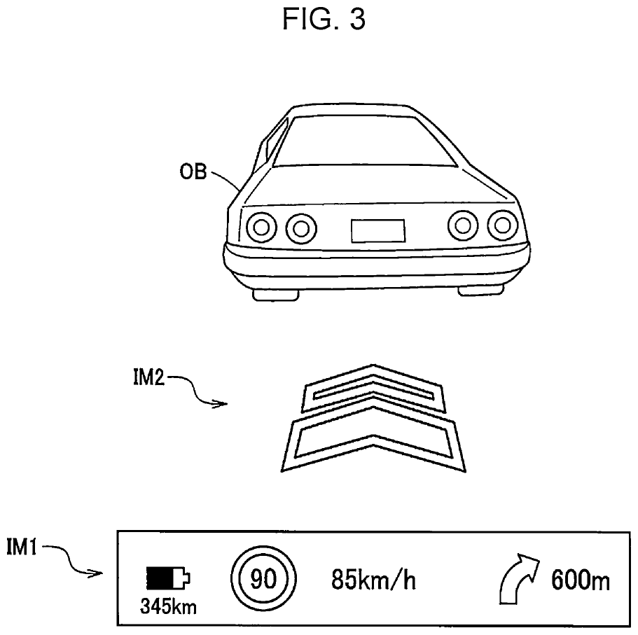

FIG. 3 illustrates an example image displayed by the screen 160. In the first projection region PR1 that corresponds to the first region RG1 in the display panel 110, a first image IM1 is projected and displayed. In the second projection region PR2 that corresponds to the second region RG2 in the display panel 110, a second image IM2 is projected and displayed. The first image IM1 and the second image IM2 are displayed as, for example, a first virtual image and a second virtual image to the user, such as the driver. An object OB is an object in the real world, for example, a vehicle driving ahead. The object OB is, for example, displayed to the user as a real image through the transparent screen 160.

The first image IM1 that is an image of first image data includes, for example, an image of a character or an icon. The second image IM2 that is an image of second image data includes, for example, an augmented reality (AR) image. For example, the first image IM1 includes images of characters that represent various information such as a speed (85 km), a distance (600 m), or a driving range (346 km), and images of icons that represent various information such as a direction, a sign, or a remaining battery capacity by using symbols. Such icons may be referred to as symbols. The first image IM1 is, for example, meter display or display of measurement instruments. The second image IM2, which is an AR image, is, for example, an image of digital information added to the real world. For example, the second image IM2 is displayed as additional information of an object OB in the real world. The second image IM2 in FIG. 3 is displayed as an image of an arrow indicating the direction of the vehicle, which is an object OB. For example, based on a sensor or data collected in real time, the AR display provides warning or other important information on the road in navigation or a driver assistance system superimposed and displayed on the scenery the user, such as the driver, actually sees. For example, an AR image is associated with an object OB in the scenery and is displayed. For example, in a state in which an object OB can be seen by the user or an object OB is expected to appear, a second image IM2 indicating the location or direction of the object OB is displayed. In such a case, the display position of the second image IM2 changes depending on the state of the real world. On the other hand, the display position of the first image IM1 is, for example, fixed independently of the state of the real world.

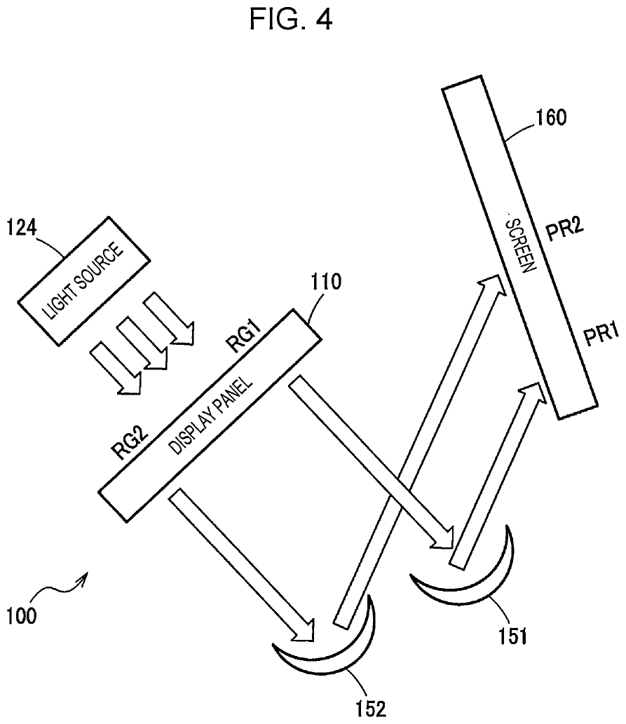

To display the first image IM1 and the second image IM2 illustrated in FIG. 3, according to the method in a comparative example of this embodiment, global dimming using a common global dimming value is performed. For example, in the comparative example, as illustrated in FIG. 4, the luminance of a single light source 124 for global dimming is adjusted by using a single global dimming value, thereby implementing global dimming. However, it is found that in accordance with the method in the comparative example, for example, in the second image IM2, the light is appropriately dimmed and, for example, black display portions appear dark and subdued; however, in the first image IM1, the light source luminance is too high and the black display portions in the background appear white.

For example, in the comparative example, a single light source 124 is provided as illustrated in FIG. 4, and thus global dimming is not performed independently on the first image IM1 and the second image IM2. For example, in a case in which the number of the light source 124 is one and the magnification of the first optical system 151 and the magnification of the second optical system 152 differ from each other, the luminance of the light emitted by the light source 124 becomes uneven in the projection image in the first projection region PR1 and in the projection image in the second projection region PR2.

For example, in FIG. 4, it is preferable that an image of a character or an icon displayed in the first region RG1 be projected in the first projection region PR1 as a high-definition image such that the user can appropriately recognize the content of the character or the icon. It should be noted that the display of the images can be implemented by, for example, modulating incident light from the light source by using the display panel 110 (electrooptic element). On the other hand, it is preferable that an AR image displayed in the second region RG2 be projected as a large image rather than a high-definition image. Accordingly, the magnification in the first optical system 151 is reduced and the magnification in the second optical system 152 is increased. The magnification may be referred to as projection magnification and is, for example, the magnification used when an image displayed in the display panel 110 is projected onto the screen 160. When the optical system is a concave mirror, the magnification is set, for example, based on the curvature, focal length, and the like of the concave mirror. As described above, by reducing the magnification in the first optical system 151, the image of a character or an icon in the first region RG1 can be projected in high definition and displayed to the user, while by increasing the magnification in the second optical system 152, the AR image in the second region RG2 can be displayed as a large image, enabling the user to appropriately recognize the AR display without missing it.

The projection image has higher luminance at lower magnification and lower luminance at higher magnification. For example, the luminance of the projection image decreases as the projection area increases. Accordingly, the image projected in the first projection region PR1 by the first optical system 151, which has a lower magnification, has high luminance, while the image projected in the second projection region PR2 by the second optical system 152, which has a higher magnification, has low luminance. Accordingly, in the comparative example in FIG. 4, which uses a single light source 124 and a single global dimming value, the portions of the projection image of the first image IM1 in FIG. 3 that are supposed to be black appear white due to high luminance. For example, when the luminance of the light source 124 is adjusted to match the AR display of the second image IM2, the luminance of the projection image of the first image IM1 becomes too high.

To solve the problem, in this embodiment, as described with reference to FIG. 1 and FIG. 2, the first light source 121 and the second light source 122, whose luminance is controlled independently, are provided, along with the first global dimming value GD1 for the first region RG1 and the second global dimming value GD2 for the second region RG2. On the first image IM1 in the first region RG1, color correction (luminance adjustment) is performed based on a first global dimming value GD1, and on the second image IM2 in the second region RG2, color correction (luminance adjustment) is performed based on a second global dimming value GD2. With this configuration, for example, when portions of the first image IM1 supposed to be displayed in black becomes whitish as described above, the portions of the first image IM1 supposed to be displayed in black can be appropriately displayed in black similarly to the second image IM2. Accordingly, in both of the first image IM1 and the second image IM2, black displayed portions can be appropriately displayed in black. In addition, displayed objects other than the portions displayed in black can also be adjusted to appropriate luminance and displayed.

As described above, in this embodiment, when light from the first light source 121 enters the first region RG1 in the display panel 110 and light from the second light source 122 enters the second region RG2 in the display panel 110, a region to which a pixel belongs is determined and color correction is performed on input image data IMI based on the region determination result. More specifically, based on a first global dimming value GD1, color correction is performed on first image data of input image data IMI to be displayed in the first region RG1. Similarly, based on a second global dimming value GD2, color correction is performed on second image data of input image data IMI to be displayed in the second region RG2. The input image data IMI subjected to the color correction is output as image data IMD to the display device 100. With this configuration, when the light from the first light source 121 and the second light source 122 enter the first region RG1 and the second region RG2 and the first image and the second image are projected, color correction can be performed on the first image data based on the first global dimming value GD1, and color correction can be performed on the second image data based on the second global dimming value GD2. Accordingly, the color correction, which is appropriate luminance adjustment based on the first global dimming value GD1 of the first light source 121 and the second global dimming value GD2 of the second light source 122, can be performed on the first image data and the second image data of the input image data IMI. With this configuration, for example, the black display portions in the projection images of the first image and the second image can be appropriately displayed in black, and the problems occurred in the comparative example in FIG. 4 can be solved. In addition, displayed objects in the projection images of the first image and the second image other than the black display portions can also be displayed with appropriate luminance.

The color correction performed on the first image data based on the first global dimming value GD1 and the color correction on the second image data based on the second global dimming value GD2 are, for example, luminance adjustments performed to reduce the luminance of each image data in the first image data and the second image data as the luminance of each light source of the first light source 121 and the second light source 122 increase. The color correction based on the first global dimming value GD1 is performed to the pixel values of the entire first image data, and the color correction based on the second global dimming value GD2 is performed to the pixel values of the entire second image data. For example, the color correction can be implemented by multiplying pixel values (RGB) of image data by a value corresponding to the inverse of a global dimming value and the like.

For example, it is assumed that to prevent the portions displayed in black in the first region RG1 in FIG. 2 and FIG. 3 from becoming whitish, the luminance of the first light source 121 is reduced based on the first global dimming value GD1. In such a case, the luminance of the displayed objects such as a character, an icon, or the like not displayed in black decreases, and thus, the color correction circuit 30 performs, for example, color correction to increase pixel values corresponding to the luminance of the displayed objects such that the luminance of the displayed objects becomes closer to the luminance in the original input image data IMI. Regarding the black displayed portions, the original luminance of these portions is, for example, zero, and thus such correction likely causes no problem. When the luminance of the light source changes, the color tone of the display image may also change. Accordingly, when adjusting the luminance of the first light source 121 and the second light source 122 based on the first global dimming value GD1 and the second global dimming value GD2, the color correction circuit 30 may perform color correction on the first image data and the second image data to prevent any change in color tone of the display image due to the change in luminance of the light sources. The color correction by the color correction circuit 30 can be implemented by using, for example, a conversion table or the like for converting the pixel value (luminance) of each image data in each region of the input image data IMI based on each global dimming value. For example, by using the conversion table, pixel values of image data corresponding to changes in the luminance of the light sources can be converted and color correction for adjusting the color tone of the display image can be implemented. The conversion characteristics of the conversion table may have characteristics of a gamma curve.

As described with reference to FIG. 2, the first region RG1 is the region projected by the first optical system 151, and the second region RG2 is the region projected by the second optical system 152. For example, the first image in the first region RG1 is projected in the first projection region PR1 in the screen 160 by the first optical system 151, and the second image in the second region RG2 is projected in the second projection region PR2 in the screen 160 by the second optical system 152. Each optical system of the first optical system 151 and the second optical system 152 can be implemented by, for example, a mirror that reflects image light (video light) from each region of the first region RG1 and the second region RG2, and more specifically, by a concave mirror or the like. With this structure, the first image in the first region RG1, where the light from the first light source 121 enters, can be projected by the first optical system 151 and the second image in the second region RG2, where the light from the second light source 122 enters, can be projected by the second optical system 152, enabling the projection images to be displayed. In such a case, the optical characteristics such as magnification of each optical system of the first optical system 151 and the second optical system 152 may differ, and due to the differences, the projection images of the first image and the second image may have inappropriate luminance. For example, portions supposed to be displayed in black may appear whitish as described above. Also in such a case, in this embodiment, the color correction is performed on the first image data and the second image data based on the first global dimming value GD1 and the second global dimming value GD2. Accordingly, even if optical characteristics such as magnification or the like of each optical system differ from the other, by adjusting the luminance by the color correction, the occurrence of inappropriate display due to the difference can be suppressed.

In this embodiment, the magnification in the first optical system 151 is lower than the magnification in the second optical system 152, and the first global dimming value GD1 is smaller than the second global dimming value GD2. With this configuration, the first image in the first region RG1 can be projected with a low magnification rate by the first optical system 151, and the second image in the second region RG2 can be projected with a high magnification rate by the second optical system 152. Accordingly, for example, the first image can be displayed in high definition, while the displayed object of the second image can be displayed in a large size. Since the first global dimming value GD1 is smaller than the second global dimming value GD2, the luminance of the projection image of the first image can be low, suppressing the occurrence of the above-described whitish display of black displayed portions.

As illustrated in FIG. 2, the first region RG1 and the second region RG2 are projected on the same screen 160. For example, the light from the first light source 121 and the second light source 122 enters the first region RG1 and the second region RG2 in the same single display panel 110 and the light of the images from the first region RG1 and the second region RG2 is projected onto the same single screen 160. For example, the first image in the first region RG1 is projected in the first projection region PR1 in the screen 160, and the second image in the second region RG2 is projected in the second projection region PR2 in the same screen 160. With this structure, the first image by the light from the first light source 121 in the first region RG1 and the second image by the light from the second light source 122 in the second region RG2 can be projected onto the same single screen 160, enabling the projection images of the first image and the second image to be displayed.

The first image that is an image of the first image data includes an image of a character or an icon, and the second image that is an image of the second image data includes an image of AR display. With this configuration, the first image, which is an image of a character or an icon, can be projected by the light from the first light source 121, while the second image, which is an image of AR display, can be projected by the light from the second light source 122. Accordingly, projection images can be displayed such that the first image, which is an image of a character or an icon, is projected in the first projection region PR1, while the second image, which is an image of AR display, is projected in the second projection region PR2. With this configuration, projection image display suitable for, for example, HUDs for vehicle can be provided.

### 2. Example Configurations

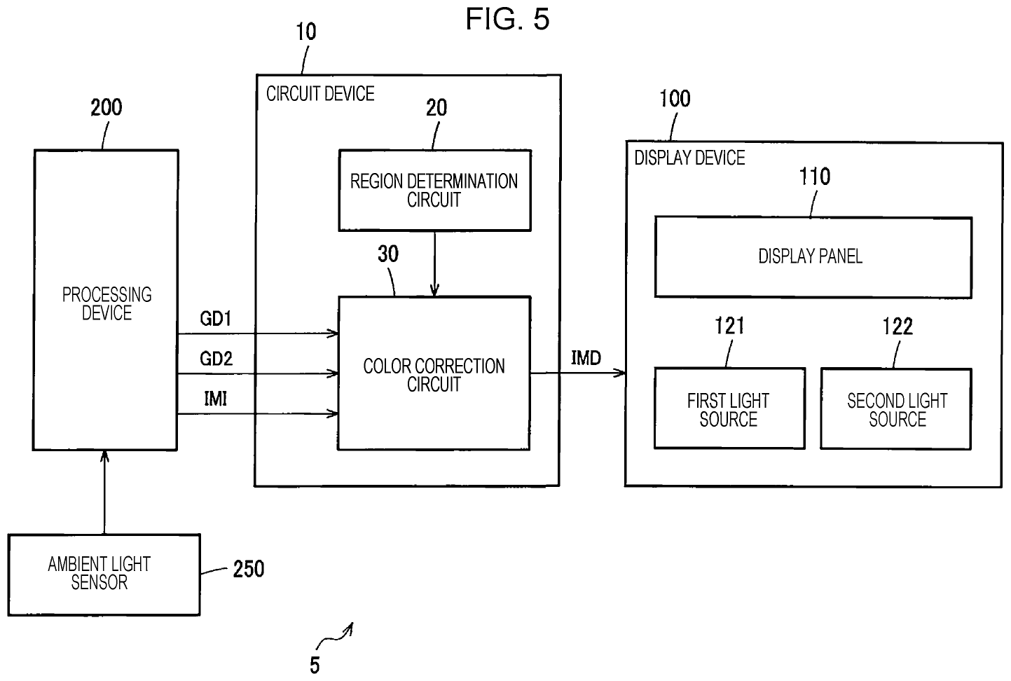

Next, various example configurations of the circuit device 10 according to the embodiment will be described. FIG. 5 illustrates an example first configuration of the circuit device 10 according to the embodiment. In the example first configuration in FIG. 5, a first global dimming value GD1 and a second global dimming value GD2 are input from an external processing device 200. For example, based on ambient light detection information from an ambient light sensor 250, the processing device 200 generates a first global dimming value GD1 and a second global dimming value GD2 and outputs the values to the circuit device 10. For example, the processing device 200 outputs the first global dimming value GD1 and the second global dimming value GD2 to set the first light source 121 and the second light source 122 to provide higher luminance as ambient light becomes brighter. The processing device 200 is, for example, a system on a chip (SoC), and may be referred to as a master device. The processing device 200 can be implemented by, for example, a microcomputer, a central processing unit (CPU), a micro-processing unit (MPU), or other components. For example, the circuit device 10 communicates with the processing device 200, and input image data IMI, a first global dimming value GD1, and a second global dimming value GD2 from the processing device 200 are input to the circuit device 10. The color correction circuit 30 in the circuit device 10 performs color correction on each image data of the first image data and the second image data of the input image data IMI to be displayed in the first region RG1 and the second region RG2 based on each global dimming value of the first global dimming value GD1 and the second global dimming value GD2 input from the processing device 200 respectively. With this configuration, the color correction circuit 30 can perform color correction on the first image data and the second image data of the input image data IMI based on the first global dimming value GD1 and the second global dimming value GD2 input from the processing device 200.

Accordingly, when the luminance of each light source of the first light source 121 and the second light source 122 is controlled based on the first global dimming value GD1 and the second global dimming value GD2 from the processing device 200, appropriate color correction corresponding to the luminance of each light source can be performed on the first image data and the second image data.

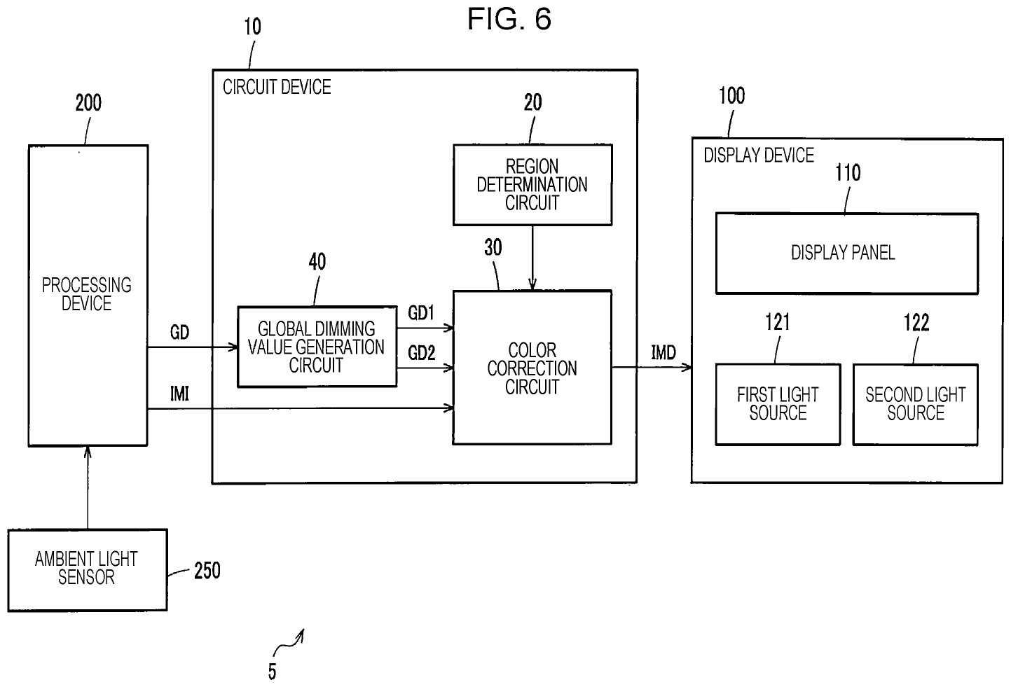

FIG. 6 illustrates an example second configuration of the circuit device 10 according to the embodiment. In the example second configuration in FIG. 6, the circuit device 10 includes a global dimming value generation circuit 40. The global dimming value generation circuit 40 determines a first global dimming value GD1 and a second global dimming value GD2 based on a global dimming value GD input from the external processing device 200. It should be noted that one of the first global dimming value GD1 and the second global dimming value GD2 may be the same value as the global dimming value GD. For example, based on ambient light detection information from the ambient light sensor 250, the processing device 200 generates a global dimming value GD and outputs the value to the circuit device 10. For example, the processing device 200 outputs a global dimming value GD for setting the light sources to provide higher luminance as ambient light becomes brighter. Based on the global dimming value GD, the global dimming value generation circuit 40 generates a first global dimming value GD1 and a second global dimming value GD2 to set the first light source 121 and the second light source 122 to provide higher luminance as ambient light becomes brighter. If optical characteristics such as magnification of the first optical system 151 and the second optical system 152 in FIG. 2 differ, the global dimming value generation circuit 40 generates a first global dimming value GD1 and a second global dimming value GD2 that are adjusted based on the difference. For example, as described with reference to FIG. 3, when the black displayed portions of the first image appear whitish, the global dimming value generation circuit 40 adjusts the first global dimming value GD1 and the second global dimming value GD2 such that the luminance of the first light source 121 becomes lower than the luminance of the second light source 122. In such a case, the adjustment values are input, for example, from the processing device 200 and stored in a register section (not illustrated) in the circuit device 10. With this global dimming value generation circuit 40, the color correction circuit 30 can perform color correction on the first image data and the second image data of the input image data IMI based on the first global dimming value GD1 and the second global dimming value GD2 generated by the global dimming value generation circuit 40 based on the global dimming value GD from the processing device 200. Accordingly, appropriate color correction, for example, corresponding to the luminance of the first light source 121 and the second light source 122 can be performed on the first image data and the second image data.

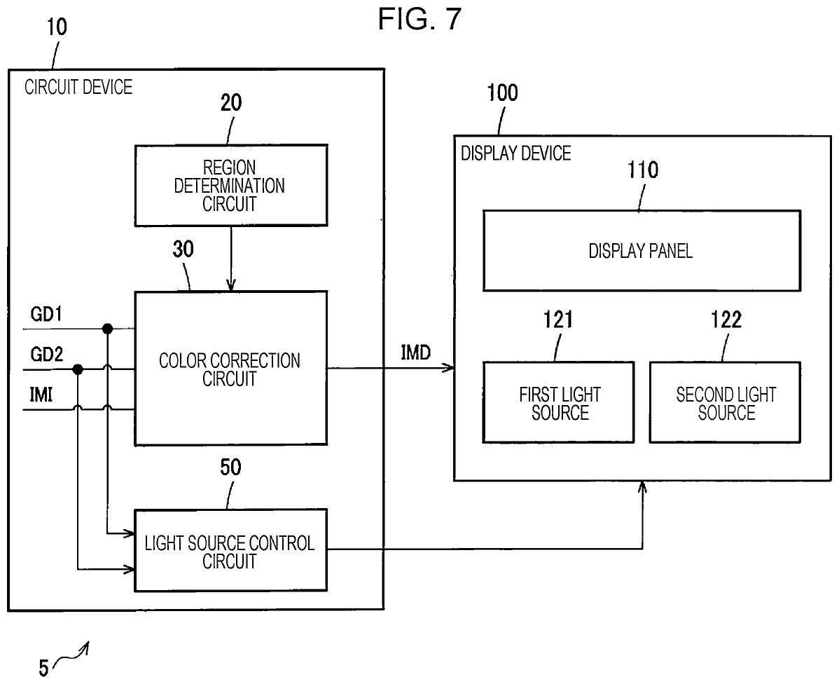

FIG. 7 illustrates an example third configuration of the circuit device 10 according to the embodiment. In the example third configuration in FIG. 7, the circuit device 10 includes a light source control circuit 50. The light source control circuit 50 controls the first light source 121 based on a first global dimming value GD1 and controls the second light source 122 based on a second global dimming value GD2. The first global dimming value GD1 and the second global dimming value GD2 in this example may be input from the processing device 200 as in FIG. 5 or may be generated by the global dimming value generation circuit 40 as in FIG. 6. The light source control circuit 50 performs control, for example, such that the first light source 121 and the second light source 122 are set to provide higher luminance as ambient light becomes brighter. If optical characteristics such as magnification of the first optical system 151 and the second optical system 152 in FIG. 2 differ, the light source control circuit 50 controls the luminance of the first light source 121 and the second light source 122 based on the difference. For example, in FIG. 3, when the black displayed portions of the first image appear whitish, the light source control circuit 50 controls the light sources such that the luminance of the first light source 121 becomes lower than the luminance of the second light source 122. This light source control circuit 50 can perform control such that the first light source 121 and the second light source 122 provide appropriate luminance (brightness) based on the first global dimming value GD1 and the second global dimming value GD2. With this configuration, for example, if optical characteristics such as magnification of the first optical system 151 and the second optical system 152 differ, the first light source 121 and the second light source 122 can be set to provide appropriate luminance based on the difference. In addition, in the example third configuration in FIG. 7, the first light source 121 and the second light source 122 can be controlled without providing a light source control circuit outside of the circuit device 10.

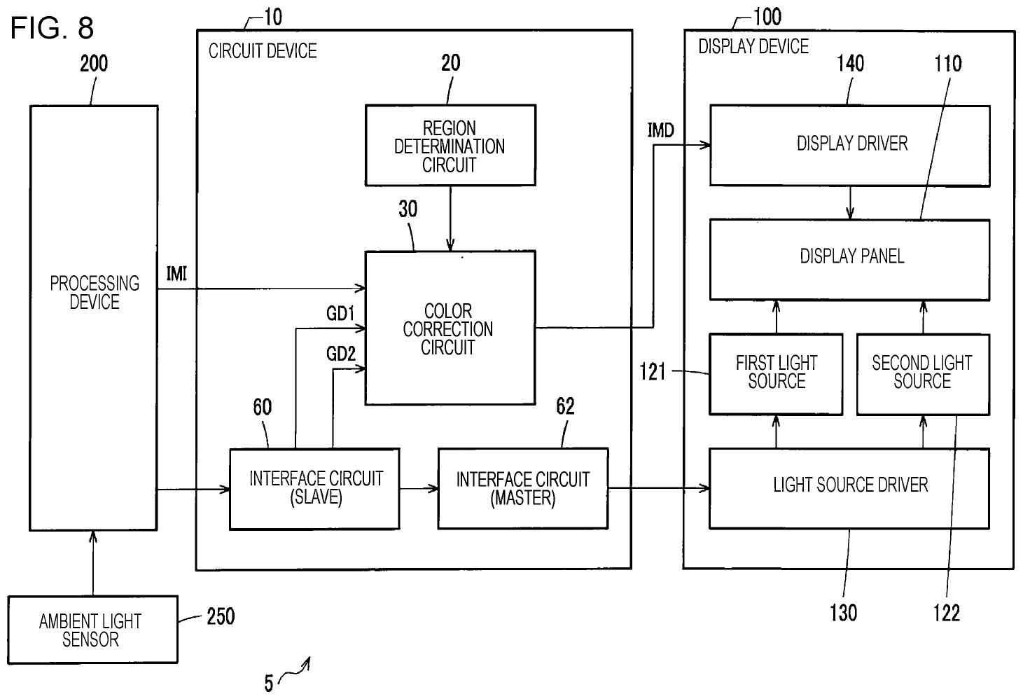

FIG. 8 illustrates a detailed example configuration of the circuit device 10 according to the embodiment. The circuit device 10 in FIG. 8 further includes, in addition to the region determination circuit 20 and the color correction circuit 30, interface circuits 60 and 62. It should be noted that the circuit device 10 in FIG. 8 may include the global dimming value generation circuit 40 described in FIG. 6 or the light source control circuit 50 described in FIG. 7. In FIG. 8, in addition to the display panel 110, the first light source 121, and the second light source 122, the display device 100 further includes a light source driver 130 and a display driver 140.

The interface circuit 60 is a circuit that performs interface processing with the processing device 200, and is, for example, a host interface circuit. The interface circuit 62 is a circuit that performs interface processing with the light source driver 130. The interface circuits 60 and 62 are, for example, serial interface circuits, for example, Serial Peripheral Interfaces (SPIs) or Inter-Integrated Circuits (I2Cs). For example, when the interface circuits 60 and 62 are SPI serial interface circuits, the interface circuit 60 functions as a slave and the interface circuit 62 serves as a master, and the interface circuit 60 and the interface circuit 62 have a bypass bridge path therebetween.

In the processing device 200 in FIG. 8, via the interface circuit 60, a first global dimming value GD1 and a second global dimming value GD2 in FIG. 5 are written in a register section (not illustrated) in the circuit device 10 and set. In such a case, the first global dimming value GD1 and the second global dimming value GD2 are output to the light source driver 130 via the bypass bridge path between the interface circuit 60 and the interface circuit 62. In the processing device 200 in FIG. 6, the global dimming value GD is written in the register section in the circuit device 10 and set. The processing device 200 may set, to the register section in the circuit device 10, an adjustment value to generate a first global dimming value GD1 and a second global dimming value GD2 from the global dimming value GD.

The light source driver 130 in the display device 100 drives the first light source 121 and the second light source 122. This light source driver 130 in FIG. 8 controls the luminance of the first light source 121 and the second light source 122 based on the first global dimming value GD1 and the second global dimming value GD2 input from the interface circuit 62 of the circuit device 10. To the display driver 140, the input image data IMD is input from the circuit device 10 and the display driver 140 drives the display panel 110. For example, the display driver 140 drives the display panel 110 to display an image based on the image data IMD.

### 3. Display System

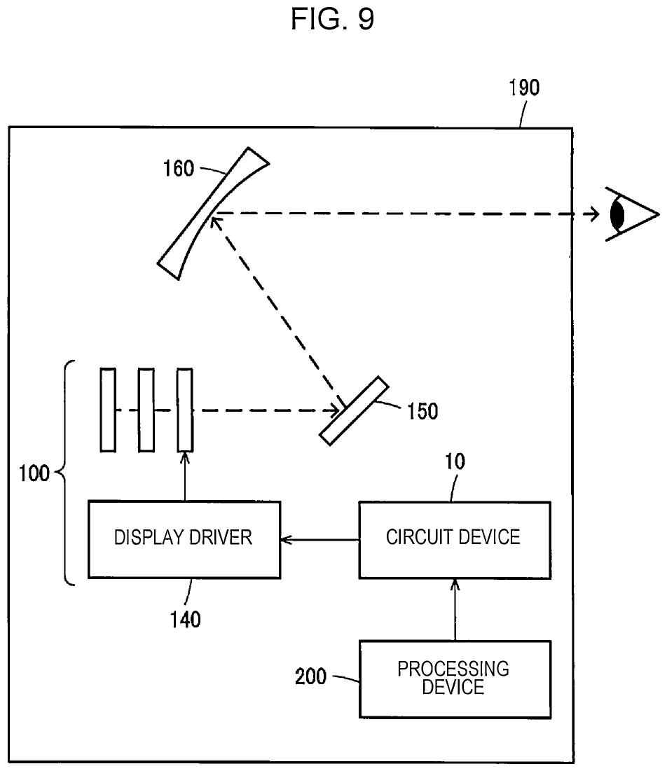

FIG. 9 illustrates an example configuration of a head-up display 190 that is an example of the display system 5 according to the embodiment. The head-up display 190, which is the display system 5 according to the embodiment, includes the circuit device 10 and the display device 100. It should be noted that the display system 5 may include the processing device 200. The display device 100 displays a display image based on data of an output image from the circuit device 10. In the case of the display system 5, which is the head-up display 190, the display device 100 displays a virtual image to the user by projecting the display image. For example, the display device 100 includes the display panel 110 and a backlight 120. The display device 100 may include the display driver 140 that drives the display panel 110 and a diffusion plate 115 provided between the display panel 110 and the back light 120. The display device 100 may include a projection optical system such as a mirror 150 that reflects projection light of a projection image. For example, the first light source 121 and the second light source 122 are provided as the backlight 120, and the first optical system 151 and the second optical system 152 are provided as a projection optical system.

The display driver 140 drives data lines and scanning lines of the display panel 110 to display a display image based on data of an output image from the circuit device 10. The light emitted by the backlight 120 transmits the diffusion plate 115 and the display panel 110 and reflected by the mirror 150 toward the screen 160. The screen 160 is, for example, a transparent screen, and more specifically, for example, a windshield of a vehicle. The reflection surface of the screen 160 is, for example, a concave surface and the projection image is a virtual image when viewed from the user. In other words, for the user, it looks as though the projection image is formed at a point farther away than the screen 160. With this configuration, the projection image can be displayed within the background.

The display system 5 according to the embodiment is not limited to the configuration in FIG. 9, and various modifications may be made. For example, as the display panel 110, a display panel other than the liquid crystal display panel may be used, or various modifications of the arrangement of the diffusion plate 115 and the projection optical system may be made. The display system 5 according to the embodiment is not limited to the head-up display 190 as in FIG. 9, and other display systems for automobiles such as a cluster display or display systems for devices other than automobiles may be used. For example, the display system 5 according to the embodiment may be a head-mounted display device or other devices.

As described above, the circuit device according to the embodiment is a circuit device configured to control a display device including a first light source, a second light source, and a display panel. The circuit device includes a region determination circuit configured to determine a region to which a pixel belongs, and a color correction circuit configured to perform color correction on input image data based on the region determination result. Light from the first light source controlled based on a first global dimming value enters a first region in the display panel, and light from the second light source controlled based on a second global dimming value enters a second region in the display panel. The color correction circuit performs color correction on first image data of input image data to be displayed in the first region based on the first global dimming value, and performs color correction on second image data of the input image data to be displayed in the second region based on the second global dimming value.

According to the embodiment, when the light from the first light source and the second light source enters the first region and the second region respectively and thereby the first image and the second image are projected, color correction can be performed on the first image data based on the first global dimming value, and color correction can be performed on the second image data based on the second global dimming value. Accordingly, appropriate color correction based on a first global dimming value and a second global dimming value for the first light source and the second light source can be performed on the first image data and the second image data of the input image data.

In this embodiment, the first region may be a region projected by the first optical system, and the second region may be a region projected by the second optical system.

With this configuration, an image formed by projection can be displayed by projecting the first image in the first region where the light from the first light source enters by using the first optical system, and projecting the second image in the second region where the light from the second light source enters by using the second optical system.

In this embodiment, a magnification of the first optical system may be lower than a magnification of the second optical system, and the first global dimming value may be smaller than the second global dimming value.

With this structure, the first image in the first region can be projected with a low magnification rate by the first optical system, and the second image in the second region can be projected with a high magnification rate by the second optical system. For example, the first image can be displayed in high definition, while the displayed object of the second image can be displayed in a large size.

In this embodiment, the first region and the second region may be projected on the same screen.

With this structure, the first image formed by the light from the first light source in the first region and the second image formed by the light from the second light source in the second region can be projected onto the same single screen, enabling the projection images of the first image and the second image to be displayed.

In this embodiment, a first global dimming value and a second global dimming value may be input from an external processing device.

With this configuration, the color correction circuit can perform color correction on the first image data and the second image data of the input image data based on the first global dimming value and the second global dimming value input from the processing device.

In this embodiment, a global dimming value generation circuit configured to determine the first global dimming value and the second global dimming value based on a global dimming value input from an external processing device may be included.

With this configuration, the color correction circuit can perform color correction on the first image data and the second image data of the input image data based on the first global dimming value and the second global dimming value generated based on a global dimming value input from a processing device.

In this embodiment, a light source control circuit configured to control the first light source based on the first global dimming value and control the second light source based on the second global dimming value may be included.

With this configuration, by using the light source control circuit in the circuit device, the first light source and the second light source can be controlled to provide appropriate luminance based on the first global dimming value and the second global dimming value.

In this embodiment, the first image that is an image of the first image data may include an image of a character or an icon, and the second image that is an image of the second image data may include an image of AR display.

With this configuration, the first image that is an image of a character or an icon can be projected by the light from the first light source, while the second image that is an image of AR display can be projected by the light from the second light source.

The display system according to the embodiment includes the circuit device and the display device described above.

Although the embodiment has been described in detail above, a person skilled in the art will readily understand that various modifications can be made without substantially departing from the new matters and effects of the present disclosure. Consequently, all such modifications are included within the scope of the present disclosure. For example, in the specification or drawings, terms used at least once together with broader or equivalent different terms can be replaced with the different terms at any part in the specification or drawings. In addition, any combination of the embodiments and modifications is considered within the scope of the present disclosure. The configurations and operations of the circuit device, display system, the display device, the head-up display, and the like are not limited to the embodiments, and various modifications may be made.

What is claimed is:

1. A circuit device configured to control a display device including a first light source, a second light source, and a display panel, the circuit device comprising:
a region determination circuit configured to determine a region to which a pixel belongs; and
a color correction circuit configured to perform color correction on input image data based on the region determination result, wherein
light from the first light source controlled based on a first global dimming value enters a first region in the display panel, and light from the second light source controlled based on a second global dimming value enters a second region in the display panel, and
the color correction circuit
performs color correction on first image data of the input image data to be displayed in the first region based on the first global dimming value, and
performs color correction on second image data of the input image data to be displayed in the second region based on the second global dimming value.

2. The circuit device according to claim 1, wherein the first region is a region projected by a first optical system, and the second region is a region projected by a second optical system.

3. The circuit device according to claim 2, wherein a magnification in the first optical system is lower than a magnification in the second optical system, and the first global dimming value is smaller than the second global dimming value.

4. The circuit device according to claim 1, wherein the first region and the second region are projected on the same screen.

5. The circuit device according to claim 1, wherein the first global dimming value and the second global dimming value are input from an external processing device.

6. The circuit device according to claim 1, further comprising:
a global dimming value generation circuit configured to determine the first global dimming value and the second global dimming value based on a global dimming value input from an external processing device.

7. The circuit device according to claim 1, further comprising:
a light source control circuit configured to control the first light source based on the first global dimming value and control the second light source based on the second global dimming value.

8. The circuit device according to claim 1, wherein the first image that is an image of the first image data includes an image of a character or an icon, and the second image that is an image of the second image data includes an image of AR display.

9. A display system comprising:
the circuit device according to claim 1; and
the display device.
